(19) United States
(12) Patent Application Publication
(10) Pub. No.: US 2009/0168092 A1
(43) Pub. Date: Jul. 2, 2009

(54) JOB MANAGEMENT AND SCHEDULING METHOD FOR NETWORK SYSTEM

(75) Inventors: Chih-Ho CHEN, Yongkang City (TW); Ran-Yih WANG, Taipei City (TW)

Correspondence Address: Muncy, Geissler, Olds & Lowe, PLLC, P.O. BOX 1364, FAIRFAX, VA, 22038-1364, US

(73) Assignee: Accton Technology Corporation

(21) Appl. No.: 12/237,991

(22) Filed: Sep. 25, 2008

(30) Foreign Application Priority Data
Dec. 28, 2007 (TW) 096151020

(51) Int. Cl. G06F 3/12

(52) U.S. Cl. 358/1.15

(57) ABSTRACT

A job management and scheduling method for network system, characterized in which a job queue is pre-constructed and a job management module is used to process a job request sent by the application layer. When the job management module determines that the hardware device needed for the job request is available, it would store the job entity into the job queue and output a completion message to the application layer where the job queue executes the stored job entities independently. Based on such a method, the job management module responds to the job request of application layer in a short period of time to enable the application layer to carry out the next job request without waiting. The job queue could adjust the job entity execution order or update the parameter settings according to data dependency, privilege value, or parameter settings to execute the job request quickly and accurately.

This application claims the benefit of Taiwan Patent Application No. 096151020, filed on Dec. 28, 2007, which is hereby incorporated by reference for all purposes as if fully set forth herein.

### BACKGROUND OF THE INVENTION

1. Field of the Invention

The present invention relates to a job management and scheduling method for network system, more particularly a job management and scheduling method for network system that constructs an independently operated job queue in the network system such that the application layer needs not wait for the response of hardware device.

2. Related Art

FIG. 1 is a schematic drawing showing the execution process of the object manager of a conventional network system. As shown, the network system contains an application layer, a core layer, a device driver layer, a job queue, and an object manager (OM).

The object manager receives a job request from the application layer (step S101), then calls the procedure interface of the core layer to process this job request (step S102). The core layer parses the programming syntax of the job request to determine whether it meets the specifications (step S103), and records the job request if it does, and simultaneously calls the procedure interface of the device driver layer to execute the application specific integrated circuit (ASIC) procedure setting according to the job request (step S104). If the job entity requires the operation of related hardware device, the hardware device must give a response (step S105) before the next job entity can be executed.

Subsequently, the system detects whether the setting of ASIC procedure is completed (step S106). If yes (i.e. related job entity is executed), the device driver layer sends a completion message to the object manager via the core layer (step S107). When the application layer receives the completion message from the object manager, it would end the job request (step S108) and execute the next job request.

The drawback of the aforesaid technique is that if the required hardware device input/output (I/O) responds that the hardware device is busy or that part of the required resources is occupied, the procedure interface of the device driver layer will not be able to drive the hardware device to execute the procedure setting requested by the job entity until the hardware device I/O has completed its job or releases the resources. Consequently, the execution of job request sent out by the application layer would be prolonged while waiting for hardware device I/O, thereby reducing the work efficiency of the entire network system.

### SUMMARY OF THE INVENTION

In light of the drawback of prior art, the objective of the invention is to provide a job management and scheduling method for network system, which, through an independently operated job queue, carries out the scheduling and operation of job entities to enable the application layer to execute job requests continuously without waiting for the response of hardware device, thereby allowing the continuous execution of job requests without interruption.

To solve the system problem described above, the invention discloses a job management and scheduling method for network system, which uses a schedule processing module to receive a job entity, store the job entity and schedule an execution time for executing the job entity such that an independently operated job queue is constructed. The invention uses a job management module to analyze the job request sent by the application layer so as to extract job entities of the job request and determine whether the hardware device needed by the job request is available, and based on which, determine whether to send a completion message to the application layer, store the job entities of the job request into the job queue, and ask the job queue to execute the scheduled job entities.

According to the job management and scheduling method for network system disclosed by the invention, when the job queue receives the execution request from the job management module, it takes out and executes the scheduled job entities in sequence until all job entities are completed.

According to the job management and scheduling method for network system disclosed by the invention, the job queue can execute job entities in a variety of manners. Approach 1, execute the job entities on a first-in, first-out basis; Approach 2, assign a privilege value to each job entity and schedule the job entity execution order based on the privilege value, from high to low; the privilege value can be assigned based on the data dependency of each job entity.

According to the job management and scheduling method for network system disclosed by the invention, when the job management module stores a new job entity into the job queue, if it detects there is an identical job entity with different parameter settings in the job queue, the job management module would update the parameter settings of job entity in the job queue, and adjust the execution time for job entities in the job queue based on the privilege value and data dependencies of all job entities in the queue.

According to the job management and scheduling method for network system disclosed by the invention, the network system comprises a plurality of objects, each object having different program commands, and each command is for controlling the hardware device of the network system to carry out different actions, such as receiving and sending data, analyzing data, designating the port for receiving and sending data, carrying out logic operation between data, storing data, and designating the data storage site. Such program commands are collectively termed “job entity.”

According to the job management and scheduling method for network system disclosed by the invention, the job queue operates independently because when it receives the request to execute the scheduled job entities, it would execute the job entities continuously until all job entities in the schedule are completed. Even if the job entities of a job request are storing in the job queue, and the job queue again receives the request to execute the scheduled job entities during the execution period, the job queue would continue to execute the job entities based on the order of their execution time. The job queue is not interfered by other elements or processes during the execution of job entities. That is why it is called independently operated job queue.

The present invention may achieve better performance than that of prior art:

First, the application layer could receive a response to the job request from the job management module in a short period of time, thereby avoiding the prolonged execution time while waiting for a response from the hardware device I/O.

Secondly, when the job queue executes job entities with identical parameter settings, it would adjust the execution time for job entities, update parameter settings or combine identical job entities according to the parameter settings, privilege value, or data dependency of job entities. As such, the storage space of job queue will not be occupied by identical job entities, thereby allowing the storage of job entities corresponding to other job requests and preventing overflow, which tends to cause operating error of the network system.

### BRIEF DESCRIPTION OF THE DRAWINGS

The present invention will become more fully understood from the detailed description given herein below for illustration only, and which thus is not limitative of the present invention, and wherein:

FIG. 1 is a process flow diagram of the prior art;

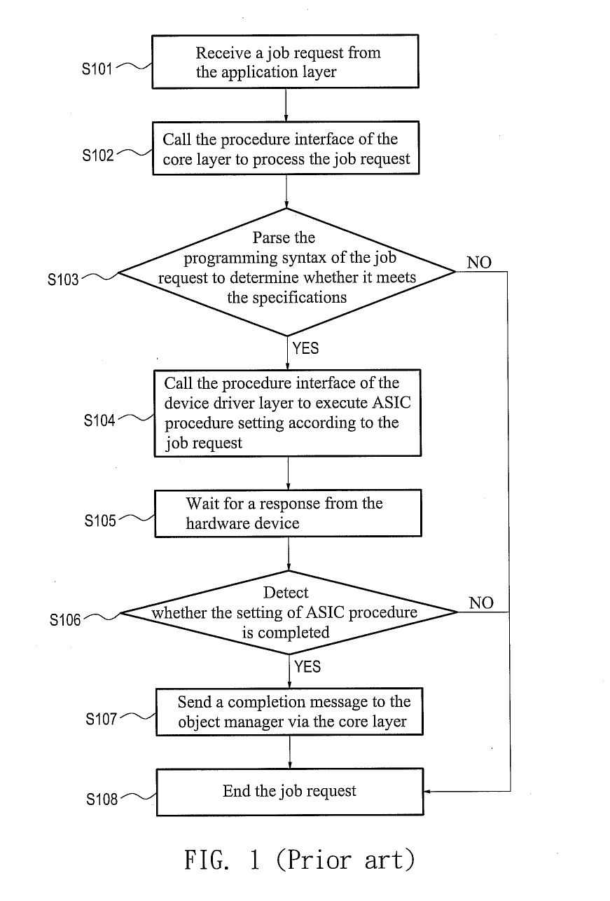

FIG. 2 is a diagram showing a simple configuration of the network system according to an embodiment of the invention;

FIG. 3 is a process flow diagram of the job management and scheduling method according to an embodiment of the invention;

FIG. 4 is a process flow diagram of the job queue operation according to an embodiment of the invention; and

FIG. 5 is a process flow diagram of storing job entities according to an embodiment of the invention.

### DETAILED DESCRIPTION OF THE INVENTION

The objects and features of the invention are described in detail below with embodiments in reference to the accompanying drawings.

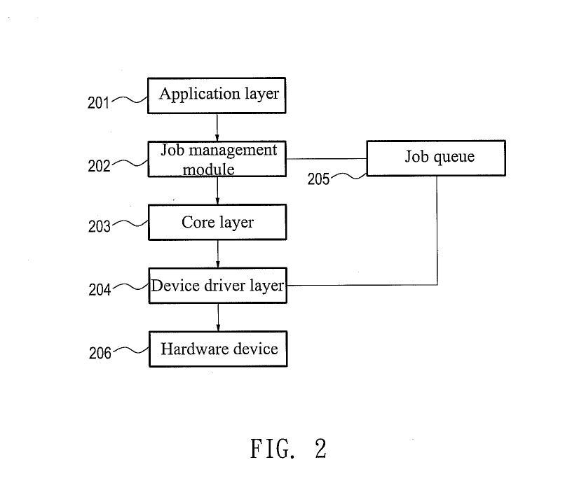

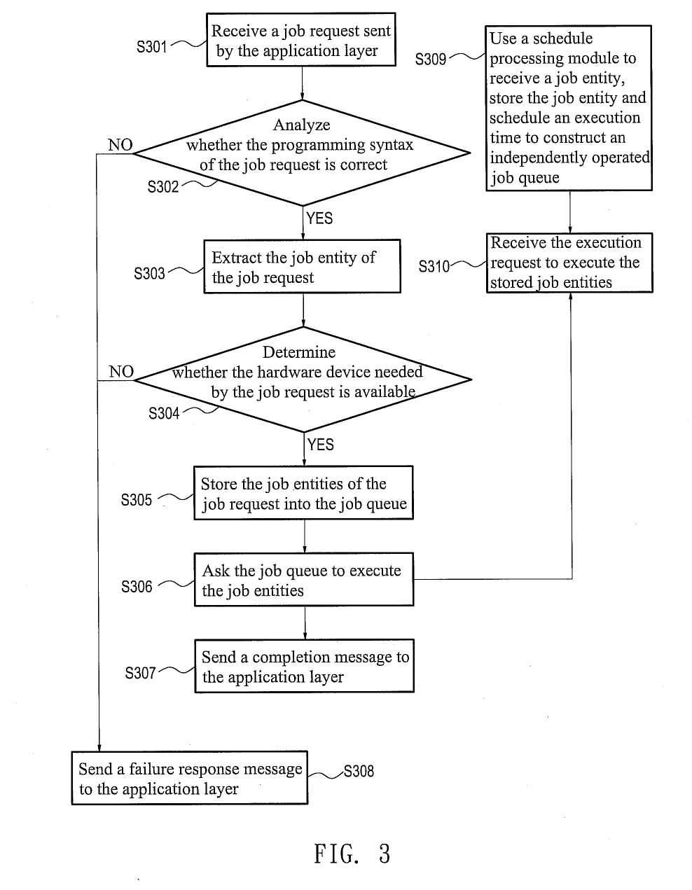

Referring to FIG. 2 and FIG. 3 which show respectively a simple system configuration and flow process of the job management and scheduling method for network system according to an embodiment of the invention, the system configuration includes an application layer 201, an job management module 202, a core layer 203, and a device driver layer 204, and the flow process includes the following steps:

Use a schedule processing module to receive a job entity, store the job entity and schedule an execution time for executing the job entity to construct an independently operated job queue (step S309). In this step, the job queue 205 manages, receives, and executes all job entities through a schedule processing module. The network system contains a plurality of objects, each object having different program commands, and each command is for controlling the hardware device of the network system to carry out different actions, such as receiving and sending data, analyzing data, designating the port for receiving and sending data, carrying out logic computation between data, storing data, and designating the data storage site. Such commands are collectively termed “job entity.”

Firstly, the schedule processing module is used to analyze all objects of the network system, each object containing a plurality of job entities. Next, the schedule processing module computes the sum of all job entities of the object, and provides a memory space in the network system by dividing the sum of job entities. Finally, the schedule processing module stores all job entities, and schedules the execution time for each job entity to construct an independently operated job queue.

In the construction of job queue, the maximum schedule load of the job queue 205 can be equal to the sum of job entities, or set at a number higher than the sum of job entities to accommodate extra events. Subsequently, the job entities are numbered according to the order of storing the job entities of the object in the hardware device. Such numbers also represent the storage sequence of the job entities in the job queue 205.

The network system is assumed to have three objects—Object A, Object B and Object C. Object A has 10 job entities, Object B has 20 job entities, while Object C has 50 job entities. The job entities of Object A are numbered 1 to 10; the job entities of Object B are numbered 11 to 30; the job entities of Object C are numbered 31 to 80. The maximum schedule load of the job queue 205 will be 80 or a higher value. When the job queue 205 stores the job entities of Object A, Object B and Object C, it puts them at locations in the order of 1^{st} to 10^{th}, 11^{th} to 30^{th}, and 31^{st} to 80^{th} to facilitate subsequent comparison.

Hence the number of job entities that can be stored by the job queue 205 can match the number of job entities produced by the job requests under the maximum load of the network system.

When the job queue receives a request to execute the job entities in the schedule, it would proceed continuously until all job entities in the schedule are executed. Even if the job entities of a job request intend to store in the job queue and the job queue again receives the request to execute job entities in the schedule, the job queue would sequentially execute the job entities according to execution time of each job entity. While executing the job entity, the job queue does not interfere with other elements or processes. This is why the job queue is called independently operated.

A job management module 202 is utilized to parse the job request sent from an application layer 201 so as to extract a job entity of the job request. In this step, first use the job management module 202 to receive the job request sent by the application layer 201 (step S301). Next, the job management module 202 would call the procedure interface of the core layer 203 to analyze whether the programming syntax of the job request is correct (step S302).

If the result of analysis is incorrect, the core layer 203 would send the failure result to the job management module 202 to send a failure response message to the application layer 201 (step S308), and end the job request, on the other hand, if the result of analysis is correct, the core layer 203 would extract the job entity of the job request (step S303).

The core layer 203 parses the objects that need to be called and used according to the programming syntax of the job request, and identifies the job entities contained in the objects when called objects or functions are determined as correct.

The hardware device needed by the job request is determined to be available (step S304) to decide whether to store the job entities of the job request into the job queue 205. In this step, the device driver layer 204 as called by the core layer 203 enables its procedure interface to work with the job management module 202 to determine the current status of the hardware device 206.

If it is determined that the hardware device 206 is not available, the device driver layer 204 would inform the job management module 202 to respond to the application layer 201 with a failure message (step S308) and end the job request; if it is determined that the hardware device 206 is available, the device driver layer 204 would store the job entities of the job request into the job queue 205 (step S305) and ask the job queue 205 to execute the job entities (step S306), and at the same time, send a completion message to the application layer 201 via the job management module 202 (step S307).

There are at least three ways to determine the status of the hardware device 206:

1. The job management module 202 obtains the parameter specifications of the hardware device 206 required for the job request from the device driver layer 204 and compares whether the parameter settings of the job request meet the parameter specifications. For instance, the port numbers of the hardware device 206 include Port-1 to Port-1000. If the port number of the job request command does not fall within the range, the job management module 202 will send a failure response message to the application layer 201. Conversely, the job management module 202 would store the job entities of the job request into the job queue 205 through the procedure interface of the device driver layer 204.

2. The job management module 202 calculates the number of entities already occupied by the jobs in the job request, and obtains the allowable schedule load of the job queue 205 from the device driver layer 204. Next, the job management module 202 compares whether the number of entities already occupied by the jobs is higher than the allowable schedule load. If yes, it means the job queue 205 is no longer able to add job entities of the new job request, and the job management module 202 would send a failure response message to the application layer 201. Conversely, the job management module 202 would store the job entities of the job request into the job queue 205 through the procedure interface of the device driver layer 204.

3. The job management module 202 asks the hardware device 206 to execute the requested job entities. When the hardware device 206 responds that the operation is completed, it means the hardware device 206 can accept the request of the job entities. In such case, the job management module 202 would store the job entities of the job request into the job queue 205 through the procedure interface of the device driver layer 204. If the hardware device 206 responds that the operation cannot be carried out, it means the hardware device 206 is unable to accept the job request. The job management module 202 would then send a failure response message to the application layer 201.

There are at least two ways for the job management module 202 to store the job entities into the job queue 205 as described below:

1. The job management module 202 stores the job entities into the job queue 205 on a first-in, first-out principle. Regardless of the importance of the job request, it merely discusses the order of job request to store the job entities.

2. The job management module 202 assigns a corresponding privilege value to each job entity based on a one-on-one basis, and stores the job entities into the job queue according to the level of the privilege value; the privilege value is assigned by the data dependencies between the job entities.

For example, the job entity a is dependent on the job entity b, and the job entity b is dependent on the job entity c. Hence the sequence of storing the job entity a in the job queue is: create the job entity c, create the job entity b, then create the job entity a, and the privilege values of the entities from high to low is the job entity c, the job entity b, the job entity a.

Conversely the removal of the job entity a would start from low to high privilege value in the following sequence: remove the job entity a, remove the job entity b, remove the job entity c.

When the storage of the job entities is completed, the job management module 202 would ask the job queue 205 to execute the stored job entities, and simultaneously output a completion message to the application layer 201 to finish the job request, and execute the next job request. The job queue 205 then receives the execution request to execute the stored job entities (step S310).

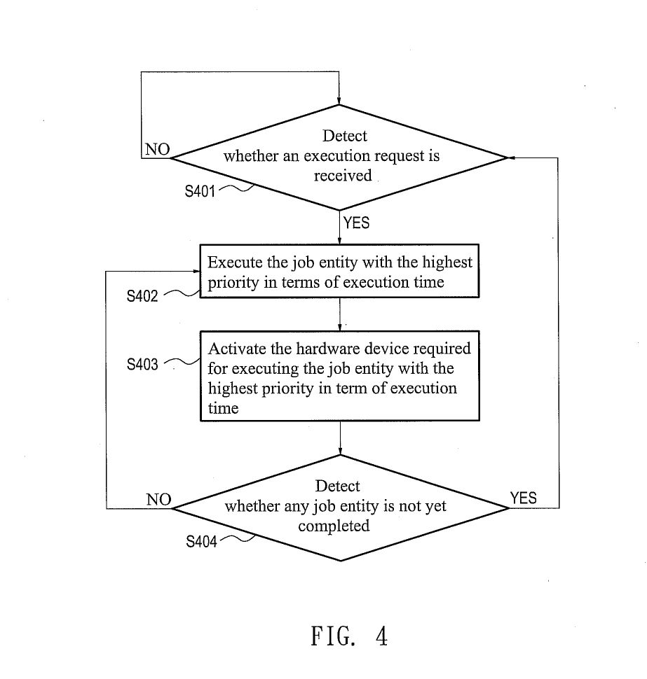

Referring to FIG. 4 which is a process flow diagram of the job queue operation according to an embodiment of the invention, the process comprises the following steps:

Detect whether an execution request is received (step S401). The device driver layer 204 would send the execution request to the job queue 205 after adding job entities to the job queue 205. Therefore, when the job queue 205 receives an execution request, the job entities must be stored therein.

If the detection result is no, return to the step of detecting whether an execution request is received (step S401); if the detection result is yes, execute the job entity with the highest priority in terms of execution time (step S402), and then activate the hardware device required for executing the job entity with the highest priority in term of execution time (step S403).

The job entities executed by the job queue 205 follows either of the two principles described below:

1. Execute all job entities based on a “first-in, first-out” principle.

2. Execute all job entities by privilege value as described above from high to low; the privilege value is assigned based on the data dependencies of the job entities.

Subsequently, the job queue 205 detects whether any job entity is not yet completed (step S404). If no, return to the step of detecting whether an execution request is received (step S401); if yes, execute the job entity with the highest priority in terms of execution time (step S402).

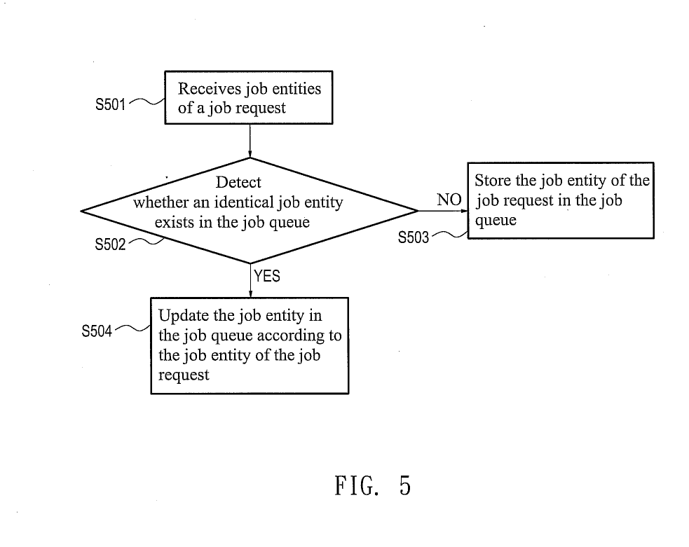

Referring to FIG. 5 which is a process flow diagram of storing job entities in the job queue according to an embodiment of the invention, the process comprises the following steps:

The job management module 202 receives job entities of a job request (steps S501), and detects whether an identical job entity exists in the job queue 205 (step S502). If not, the job management module 202 would store the job entity of the job request into the job queue 205 (step S503); if yes, the job management module 202 would update the job entity of the job queue 205 with the job entity of the job request (step S504).

If the job entities are numbered earlier, first obtain the numbers of job entities contained in the job request, and search the job entities in the job queue 205 based on the numbers to determine whether job entities are matched the numbers in the job queue 205.

If the answer is no, meaning no identical job entities are stored into the job queue 205, store the job entities of the job request into the job queue 205; if the answer is yes, update the job entity with the same number in the job queue 205.

As described earlier, if the job queue 205 is already stored with the job entities of Object B, that is to say with the job entities numbered 11 to 30, when the execution of job request calls for the execution of Object A, the job management module 202 would add the job entities of Object A in the job queue, and store them in the order from 1 to 10 since the job queue 205 does not have job entities numbered 1 to 10 present.

When the execution of job request calls for the execution of Object B, the job management module 202 would find that the job entities 11 to 30 are already stored into the job queue 205 and update those job entities.

When updating the job entities in the job queue 205, the job management module 202 would detect whether the parameter settings of two identical job entities are the same. If no, the job entity already in the job queue 205 would be replaced with the job entity of the new job request; if yes, the job entity of the new job request is deleted or combined with the job entity already in the job queue 205. Subsequently, the job management module 202 computes the data dependencies of all job entities therein, and adjusts the storage sequence of job entities accordingly.

Such process of updating job entity is to prevent the job queue 205 from repeatedly executing job entities of identical job request, which keeps the job entities contained in other job requests from being stored, thereby causing operating error of the network system.

The preferred embodiments of the present invention have been disclosed in the embodiments. However the embodiments should not be construed as a limitation on the actual applicable scope of the invention, and as such, all modifications and alterations without departing from the spirits of the invention and appended claims shall remain within the protected scope and claims of the invention.

What is claimed is:

1. A job management and scheduling method for network system, comprising steps of:
using a schedule processing module to receive a job entity, store the job entity and schedule an execution time for executing the job entity to construct an independently operated job queue;
using a job management module to analyze a job request sent from an application layer so as to extract a job entity of the job request; and
determining whether a hardware device needed by the job request is available to determine whether to store the job entity of the job request into the job queue.

2. The job management and scheduling method according to claim 1, wherein in the step of determining whether a hardware device needed by the job request is available, if a result is no, the job management module sends a failure response message to the application layer.

3. The job management and scheduling method according to claim 1, wherein in the step of determining whether a hardware device needed by the job request is available, if a result is yes, the job management module stores the job entity of the job request into the job queue, requests the job queue to execute the job entity of the job request, and sends a completion message to the application layer.

4. The job management and scheduling method according to claim 1, wherein in the step of constructing an independently operated job queue includes steps of:
using the schedule processing module to analyze all objects in the network system;
using the schedule processing module to calculate a sum of job entities of the objects; and
providing a memory space by dividing the sum of job entities;
using the schedule processing module to receive the job entities; and
storing the job entities in the memory space and scheduling an execution time for executing each job entity.

5. The job management and scheduling method according to claim 4, wherein a maximum schedule load of the job queue is equal to the sum of the job entities of the objects.

6. The job management and scheduling method according to claim 4, wherein a maximum schedule load of the job queue is greater than the sum of the job entities of the objects.

7. The job management and scheduling method according to claim 4, further comprising a step of numbering the job entities of the objects in sequence.

8. The job management and scheduling method according to claim 7, wherein the step of numbering the job entities of the objects represents an order of storing the job entities of the objects in the job queue.

9. The job management and scheduling method according to claim 7, wherein the step of storing the job entities of the job request comprises steps of:
obtaining a corresponding number of the job entity of the job request;
searching the job entities in the job queue; and
determining whether a job entity in the job queue matches the number of the job entity, if no, storing the job entity of the job request into the job queue, if yes, updating the job entity in the job queue.

10. The job management and scheduling method according to claim 9, wherein the step of updating the job entity in the job queue comprises steps of:
detecting whether parameter settings of two job entities having a same number are identical, if no, replacing the job entity in the job queue with the job entity of the job request, if yes, deleting the job entity of the job request.

11. The job management and scheduling method according to claim 10, further comprising steps of:
calculating data dependencies of all job entities in the job queue; and
adjusting execution time of all job entities in the job queue according to the data dependencies.

12. The job management and scheduling method according to claim 1, wherein the step of using a job management module to analyze a job request sent from an application layer comprises steps of:
receiving the job request sent by the application layer; and
parsing whether programming syntax of the job request is correct, if no, sending a failure response message to the application layer, if yes, extracting the job entities needed by the job request.

13. The job management and scheduling method according to claim 1, wherein the step of determining whether a hardware device needed by the job request is available comprises steps of:
obtaining parameter specifications of the hardware device needed by the job request; and
comparing whether parameter settings of the job request meet the parameter specifications, if no, sending a failure response message to the application layer, if yes, storing the job entity of the job request into the job queue.

14. The job management and scheduling method according to claim 1, wherein the step of determining whether a hardware device needed by the job request is available comprises steps of:
obtaining number of job entities already occupied by the job request and an allowable schedule load of the job queue; and
comparing whether the number of job entities already occupied by the job request is greater than the allowable schedule load, if yes, sending a failure response message to the application layer, if no, storing the job entities of the job request into the job queue.

15. The job management and scheduling method according to claim 1, wherein the step of determining whether a hardware device needed by the job request is available comprises steps of:
executing a request to the hardware device, if the hardware device being unable to execute the request, sending a failure response message to the application layer, if the hardware device completing the request, storing the job entities of the job request into the job queue.

16. The job management and scheduling method according to claim 1, wherein the step of storing the job entity of the job request into the job queue comprises steps of:
obtaining the job entity of the job request; and
detecting whether an identical entity exists in the job queue, if no, storing the job entity of the job request into the job queue, if yes, updating the job entity in the job queue with the job entity of the job request.

17. The job management and scheduling method according to claim 16, wherein the step of updating the job entity in the job queue comprises steps of:
detecting whether parameter settings of two same job entities are identical, if no, replacing the job entity in the job queue with the job entity of the job request, if yes, deleting the job entity of the job request.

18. The job management and scheduling method according to claim 17, further comprising steps of:
calculating data dependencies of all job entities in the job queue; and
adjusting execution time of all job entities in the job queue according to the data dependencies.

19. The job management and scheduling method according to claim 1, wherein the job entities are stored into the job queue through first-in first-out principle.

20. The job management and scheduling method according to claim 1, wherein the job entities are assigned a privilege value on a one-on-one basis, and stored into the job queue based on the privilege value in order.

21. The job management and scheduling method according to claim 1, wherein time of executing the job entity of the job request in the job queue is determined by data dependency.

22. The job management and scheduling method according to claim 1, wherein operation of the job queue comprises steps of:
detecting whether an execution request is received, if yes, executing the job entity with highest priority in terms of execution time and activating the hardware device needed by the job entity with the highest priority in terms of execution time, if no, returning to the step of detecting whether an execution request is received; and
detecting whether a job entity is not finished, if no, returning to the step of detecting whether an execution request is received, if yes, returning to the step of executing the job entity with the highest priority in terms of execution time.

23. The job management and scheduling method according to claim 22, wherein the job queue determines the corresponding execution time of the job entity on a first-in first-out principle.

24. The job management and scheduling method according to claim 22, wherein each job entity is assigned a privilege value, the job queue determining the execution time for the job entity based on an order of the privilege value.
